(19) United States
(12) Patent Application Publication
(10) Pub. No.: US 2017/0297879 A1
(43) Pub. Date: Oct. 19, 2017

(54) FORK-LIFT TRUCK

(71) Applicant: Toyota Material Handling Manufacturing Sweden AB, Mjölby (SE)

(72) Inventor: Oskar Franzén, Mjölby (SE)

(21) Appl. No.: 15/490,186

(22) Filed: Apr. 18, 2017

(30) Foreign Application Priority Data
Apr. 19, 2016 (SE) 1650524-0

(51) Int. Cl. B66F 9/075; B66F 17/00; G05D 1/02; B66F 9/24; B66F 9/12

(52) U.S. Cl. CPC B66F 9/0755; B66F 17/003; G05D 1/027; B66F 9/125; B66F 9/07504; B66F 9/24

(57) ABSTRACT

The present disclosure relates to a fork-lift truck, comprising, a housing, a mast, an actuating device, a framework extension assembly, a control unit, a pair of support legs. The fork-lift truck is provided with a sensor device that is arranged to detect a predetermined rotary position of at least one rotary axis of the framework extension assembly. The control unit is arranged to determine and set a maximal speed and/or a maximal acceleration, and/or a maximal deceleration, and/or a maximal lift height, and/or a maximal load weight, of the fork-lift truck based on the detected predetermined rotary position of the said at least one rotary axis.

### CROSS-REFERENCE TO RELATED APPLICATIONS

This application claims the priority benefit of Sweden Patent Application No. SE 1650524-0 filed Apr. 19, 2017, the contents of which is hereby incorporated by reference as if set forth in its entirety herein.

### TECHNICAL FIELD

The present invention relates to a fork-lift truck having a sensor device arranged to detect rotary position, a computer program product, and associated methods.

### PRIOR ART

It is know from document EP 2 263 966 B1 to measure position of members of an industrial truck. In particular the document relates to the use of RFID tags in order to achieve a good measurement of the position of said member, without the need of constant calibration, thus allowing for the absolute position to be determined for a particular member.

The above industrial truck has the disadvantage that it is needs many RFID tags to be attached along the movement direction.

### SUMMARY OF THE INVENTION

The present invention relates to a fork-lift truck including a housing, a mast, an actuating device, a framework extension assembly, a control unit, and a pair of support legs. The mast is movable horizontally in the direction of the support legs by means of the actuating device and the framework extension assembly. The framework extension assembly comprises at least two elongated elements that movably joins the mast with the housing of the fork-lift truck, are joined together at a first rotary axis. The first elongated element is attached to the housing at a second rotary axis, and that the second elongated element is attached to the mast with a third rotary axis. The fork-lift truck is provided with a sensor device that is arranged to detect a predetermined rotary position of at least one of the rotary axes of the framework extension assembly. Further, the control unit is arranged to determine and set a maximal speed and/or a maximal acceleration, and/or a maximal deceleration, and/or a maximal lift height, and/or a maximal load weight, of the fork-lift truck based on the detected predetermined rotary position of the said at least one rotary axis.

One advantage of the invention is that it avoids the need to apply a sensor assembly that needs to be present all along the way of linear movement. It becomes particularly easy to measure horizontal extension in the direction of the support legs.

The present invention also relates to a method of controlling a fork-lift truck, the fork-lift truck including a housing, a mast, an actuating device, a framework extension assembly with at least one rotary axis, a control unit, and a pair of support legs. The method comprises providing at least one sensor device associated with at least one rotary axis of a framework extension assembly. The method further comprises applying the sensor device in order to detect a predetermined rotary position of the at least one rotary axis. Additionally, the method comprises providing a control unit that determines and sets a maximal speed and/or a maximal acceleration, and/or a maximal deceleration, and/or a maximal lift height, and/or a maximal load weight, of the fork-lift truck based on the detected predetermined rotary position of the said at least one rotary axis.

The present invention also relates to a method of achieving a fork-lift truck, the method comprising providing a sensor device able to detect a rotary motion of an axis. The method further comprising applying said sensor device to a rotary axis of a framework extension assembly, wherein the sensor device is able to detect a predetermined rotary position of at least one rotary axis. Additionally, the method comprising arranging a control unit to be able to set a maximal speed and/or a maximal acceleration, and/or a maximal deceleration, and/or a maximal lift height, and/or a maximal load weight, of the fork-lift truck based on the detected predetermined rotary position of the said at least one rotary axis.

The present invention also relates to a computer program product including a program stored on a non-transitory computer-readable medium, the program configured to execute at least a portion of the disclosed methods.

### LIST OF DRAWINGS

FIG. 1 discloses a fork-lift truck according to the invention.

FIG. 2 discloses a graph of velocity as a function of horizontal extension of a method according to the invention.

FIG. 3 discloses a graph of velocity as a function of horizontal extension of a method according to the invention.

FIG. 4 discloses a graph regarding acceleration as a function of speed.

FIG. 5 discloses a flowchart for a method of controlling a fork-lift truck.

FIG. 6 discloses a flowchart for a method of achieving a fork-lift truck.

### DETAILED DESCRIPTION

The present disclosure generally refers to the area of reach fork-lift trucks. A fork-lift truck in this context is a material handling vehicle, also referred to as a floor conveyor, a fork-lift, a stacker, order pickers, very narrow aisle trucks, but primarily one common denomination are reach trucks, etc. These types of fork-lift trucks typically have the following characterising features; a mast, an actuating device, a pair of support legs. The mast is by the actuating device movable in the horizontal direction, in the direction of the support legs. The mast can be a one section mast, or two, three or four section mast, or actually any number of sections, that allows for a movement of the mast in horizontal direction. The mast can be associated with the support legs such that it has rolls or wheels that run in the support legs. The actuating device is in general able to move the mast in horizontal direction. The actuating device is able to move the mast in both a linear movement both forward and backwards. The actuating device can be a hydraulic cylinder, or two hydraulic cylinders or more hydraulic cylinders. The actuating device can have one cylinder moving the mast in one horizontal direction and a second hydraulic cylinder moving the mast in the horizontal direction. The actuator device can be visible when in operating and it can also be positioned within the support legs. The fork-lift truck can in general include a seat for an operator, a standing platform for an operator, or be a walking truck without any means for transport of the operator. The reach function can be supported by a framework extension assembly, in order to keep the mast essentially vertical when moving along the support legs. The framework extension assembly can be designed in several equally functioning ways. For example a longer element can be attached to a smaller element near the middle of the longer element. The respective two elements are then attached to the fork-lift housing and the mast, such that a sax-like function is achieved. The attachment points are at the housing rotational and also near the bottom end of the mast it is a rotary axis, and on the upper mast attachment point a guided glide path is provided. The opposite configuration is also possible with a single point of attachment at the bottom of the mast, however this may be less preferred in certain situations, as it may be more difficult to stabilize the mast in the vertical direction. In certain embodiments, it may be beneficial to have a single rotational axis at the middle section of the mast, with a guided glide path at the bottom section of the mast, combined with an actuating device/s positioned close to/or within the support legs. Of course it is possible to use a pentagram-like design of the framework extension assembly. The main function of the framework extension assembly is to make it possible for the mast to be moved in the horizontal direction but to also be kept in an essentially vertical position.

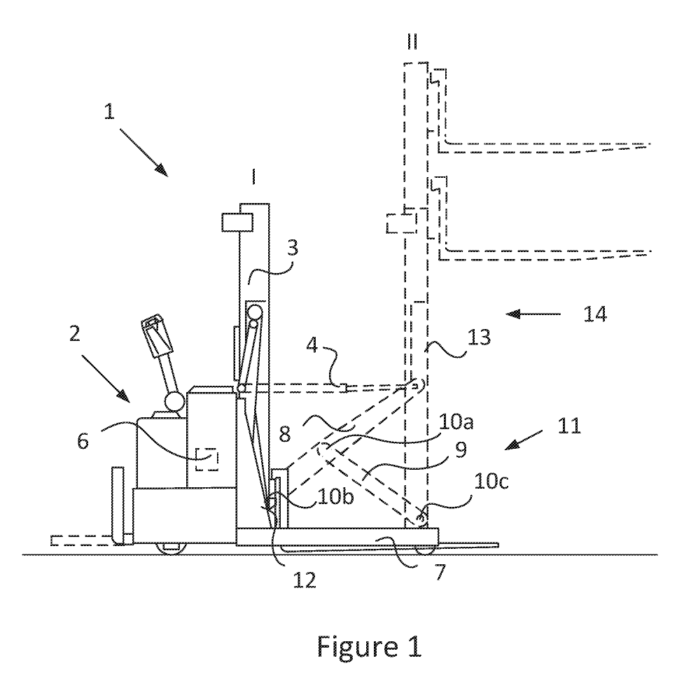

FIG. 1 discloses a general aspect of the present disclosure. A fork-lift truck 1 is disclosed with a housing 2 and a mast 3. Further there are two support legs 7 that protrude in the fork direction of the fork-lift truck 1. The support legs 7 have a wheel at one end, but it is of course possible to use rolls, and have more than one wheel per support leg 7. FIG. 1 discloses how the mast can be moved in horizontal direction between a retracted state I and a forward state II. The fork-lift truck 1 is provided with several optional features such as a platform that is pivotal and a tiller handle for controlling the fork-lift truck by an operator. The platform can be removed and the tiller handle can be replaced by another control device such as a steering wheel in combination with a seat for the operator.

In one non-limiting embodiment, the framework extension assembly 5 may have two main elements 8 and 9, see FIG. 1. An actuating device 4 is also disclosed. The first element 8 is attached in the bottom part of the housing 2, by means of a rotary axis 10b. There is a rotary axis 10a joining the two elements 8, 9 together. There is also a rotary axis 10c at the bottom portion of the mast 3. Preferably the framework extension assembly 5 is further associated with the mast 3 by means of a glide connection 13. A glide connection can be made very robust and exact. In FIG. 1 the glide connection is present at the middle section 14 of the mast 3. However it should be understood that the glide connection 13 can alter position with the rotary axis 10c at the bottom section 11 of the mast 3. Thus moving the actuating device/s 4 positioned within/or close to the support legs 7. It could be seen as the frame work extension assembly as disclosed in FIG. 1 but, inverted vertically. In some embodiments, it may be beneficial to apply the rotary axis 10b in the middle or upper part of the housing 2.

In another non-limiting embodiment, a sensor device 12 is attached to the rotary axis 10b at the bottom portion of the housing 2. The sensor device can be potentiometer, a Hall Effect sensor with corresponding magnet, or the like. The position close or within the housing 2 of the fork-lift truck gives the possibility to protect the sensor device 12 from the environment in which the fork-lift truck 1 operates. Another advantage is that the connection of a control unit 6 to the fork-lift truck 1 is simplified compared with for example a positioning on the mast 3. The sensor device 12 detects the rotary position of the rotary axis 10b. The position is communicated to the control unit 6. In certain situations, it may be beneficial to have this detection performed in a continuous manner. For detecting the horizontal extension or position of the mast 3, a linear sensor could have been considered to be used. However a linear sensor would require a linear detection along the support leg in order to detect the position of the mast 3. The detection could thus be disturbed for example by dirt and grease, making the positioning of the mast 3 less reliable. Also different types of light detectors, such as laser or ultra sound detectors are often subject to disturbance from dirt or environment. It should be understood that it is possible to attach the sensor device 12 at any rotary axis 10a, 10b, 10c, that has a rotation that corresponds to the horizontal extension of the mast 3 in the horizontal direction. And also it should be understood that it is possible to have sensors at several rotational axis 10a, 10b and/or 10c, of the framework extension assembly. This configuration can make it possible to compare and achieve an even more exact value of the horizontal extension of the mast 3 in the horizontal direction of the fork-lift truck 1.

The control unit 6 in FIG. 1 is designed as being positioned within the housing 2. The control unit 6 can be positioned at any position in the fork-lift truck 1. For example it is possible to position the control unit in a tiller handle, or in an operator's panel. The control unit 6 could also be an external control unit 6 that communicates with a wireless interface on the fork-lift truck 1. The control unit 6 may generally be a computer provided with a processor, memory, and communication interfaces with the fork-lift truck electronic components. The control unit 6 can store and execute computer software.

The general aspect of the present disclosure is that the control unit 6 is arranged such that it can control the different functions of the fork-lift truck 6, in particular lifting/lowering operations, forward and backward travelling, and also acceleration and deceleration of travel. In general it is possible to adjust the parameters in the memory of the control unit 6 in order to set particular limits to the different functions of the fork-lift truck 1. In particular it is possible to set a maximal speed and/or a maximal acceleration, and/or a maximal deceleration, and/or a maximal lift height, and/or a maximal load weight. This control is made by applying a computer readable code that when executed in the software of the control unit 6 is able to set these different parameters. The control unit 6 is thus able to transform a predetermined rotary position delivered from the sensor device 12 into a horizontal extension of the mast 3. That is, into a position in the horizontal direction of the mast 3 compared with the housing 2.

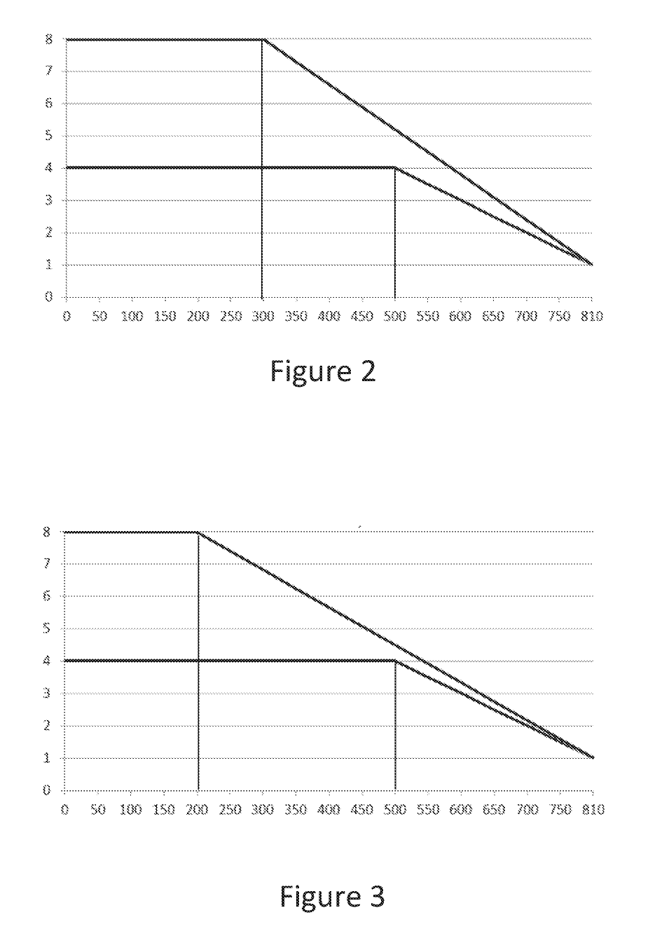

The control of the fork-lift truck 1, according to one aspect of the present disclosure, may be made such as is disclosed in FIG. 2. In this figure the vertical Y-axis represents speed and the horizontal X-axis represents horizontal extension of the mast 3 in the direction of the support legs. Horizontal extension may be defined as the distance from the housing 2 of the fork-lift 1 to the mast 3. A higher number means a higher speed or a longer horizontal extension. As can be seen in FIG. 2 for the first part of horizontal extension of the mast 3, the top speed here is represented by the number 8, or the number 4, for the lower curve, and the fork-lift truck 1 is in general not altered by the control unit 6. At a predetermined horizontal extension, the control unit is arranged to decrease the top speed. This horizontal extension in FIG. 2 is represented by the number 300 for the upper curve and by the number 500 for the lower curve. At these horizontal extensions the top speed is gradually lowered until full horizontal extension is reached at the number 810. The numbers provided are only non-limiting examples. In FIG. 3 it can be seen for the upper curve that a number of 200 can be used for allowing the top speed to be decreased.

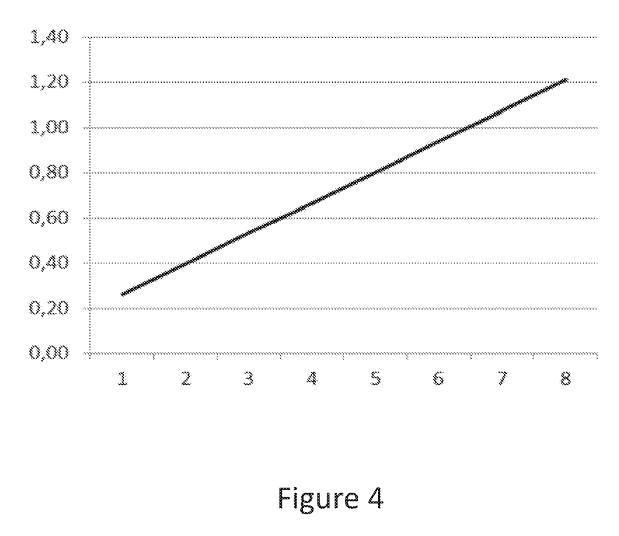

FIG. 4 discloses how the acceleration and/or deceleration of the fork-lift truck 1 can be set depending on the horizontal extension of the mast 3. The horizontal extension of the mast 3 cannot be read directly from FIG. 4, but by means of the speed number on the horizontal X-axis it is possible to convert speed to allowed acceleration by using FIG. 2 or 3. The control unit 6 thus can also alter the possible deceleration and acceleration of the fork-lift truck 1 depending on at which speed the fork-lift truck is travelling before beginning of breaking or acceleration.

It is possible to use a rotary potentiometer as the sensor device 12, for detecting the rotary position of the rotary axis 10a, 10b, and/or 10c. The advantage with these is that they are easy to handle and cost effective. In order to achieve the same detected horizontal extension each time, a calibration routing may be made at each start-up of the fork-lift truck 1. This calibration routine may be made automatically by the control unit 6.

It is also possible to use digital hall-effect sensor elements for detecting the rotary position of the rotary axis 10a, 10b and/or 10c, together with one magnet. One advantage of using this configuration is that it is possible to do without the calibration routine.

The fork-lift 1 truck may be an electric fork-lift truck comprising an electric drive motor, and an electric pump motor for a comprised hydraulic system. One particular advantage is that it is possible to operate the fork-lift truck inside a ware-house, where exhaust gases are difficult to accept. Having an electric fork-lift truck may be beneficial as it is easy to recharge compared with administering liquid fuel. And also in particular when handling food stuff that requires special packages etc. if the environment is exposed to combustion fuel exhaust gases.

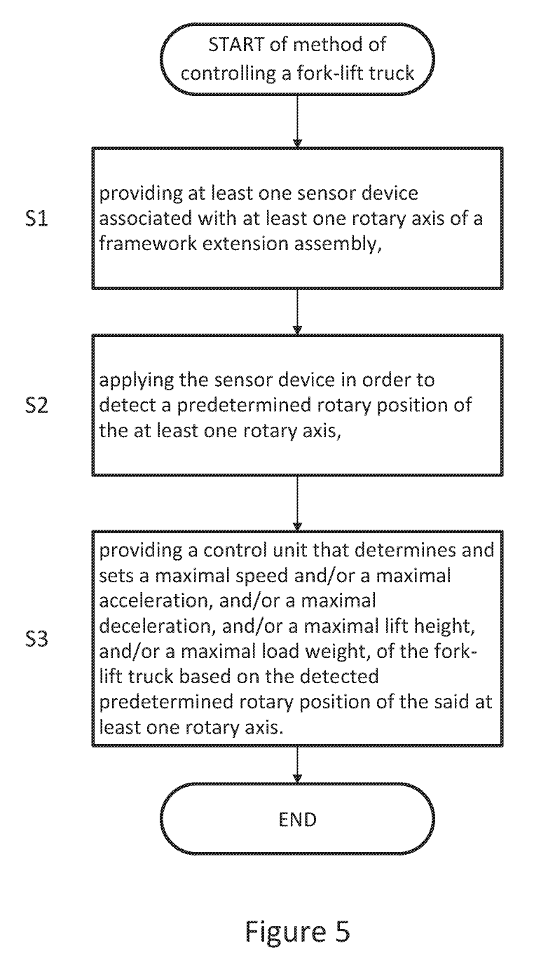

For control of the fork-lift truck 1 the control unit 6 may perform this method, see FIG. 5 with steps S1-S3 by executing the program stored on a non-transitory computer-readable medium:
S1 providing at least one sensor device associated with at least one rotary axis of a framework extension assembly,

It may be, as stated above, advantageous to measure at a rotary axis compared with a linear measurement.
S2 applying the sensor device in order to detect a predetermined rotary position of the at least one rotary axis,

It may be, as stated above, advantageous to determine a rotary position of a rotary axis, compared with a direct linear position determination.
S3 providing a control unit that determines and sets a maximal speed and/or a maximal acceleration, and/or a maximal deceleration, and/or a maximal lift height, and/or a maximal load weight, of the fork-lift truck based on the detected predetermined rotary position of the said at least one rotary axis.

Basing a linear position determination of the rotary position on a rotary axis may give many particular advantages as it may be easy to position a sensor device. It may be easy to protect the sensor device and the method can be made reliable.

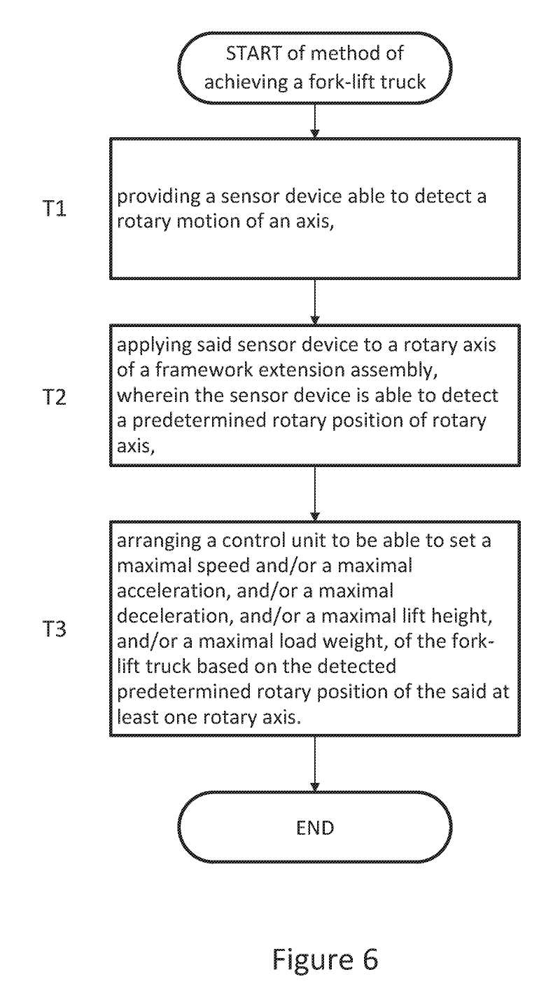

The present disclosure also relates to a method, see FIG. 6, of achieving a fork-lift truck comprising the steps of,
T1 providing a sensor device able to detect a rotary motion of an axis,
T2 applying said sensor device to a rotary axis of a framework extension assembly, wherein the sensor device is able to detect a predetermined rotary position of rotary axis,
T3 arranging a control unit to be able to set a maximal speed and/or a maximal acceleration, and/or a maximal deceleration, and/or a maximal lift height, and/or a maximal load weight, of the fork-lift truck based on the detected predetermined rotary position of the said at least one rotary axis.

By this method it may be possible to modify an already existing fork-lift truck. The method can be applied to any fork-lift truck that has a rotary axis that rotates with the horizontal extension of a mast in the horizontal direction.

The present disclosure describes embodiments with reference to the Figures, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the embodiments may be combined in any suitable manner in one or more embodiments. In the description, numerous specific details are recited to provide a thorough understanding of the embodiments. One skilled in the relevant art will recognize, however, that the embodiments may be practiced without one or more of the specific details, or with other methods, components, materials, and so forth. In other instances, well-known structures, materials, or operations are not shown or described in detail to avoid obscuring aspects of the embodiments.

Although the above discussion discloses various exemplary embodiments, it should be apparent that those skilled in the art can make various modifications that will achieve some of the disclosed advantages without departing from the true scope of the disclosure.

1. A fork-lift truck comprising:
a housing;
a mast;
an actuating device;
a framework extension assembly;
a control unit;
a pair of support legs;
wherein the mast is movable horizontally in a direction of the support legs by means of the actuating device and the framework extension assembly;
wherein the framework extension assembly comprises at least two elongated elements that movably joins the mast with the housing of the fork-lift truck, are joined together at a first rotary axis;
wherein the first elongated element is attached to the housing at a second rotary axis, and that the second elongated element is attached to the mast with a third rotary axis;
wherein the fork-lift truck is provided with a sensor device that is arranged to detect a predetermined rotary position of at least one of the rotary axes of the framework extension assembly; and
wherein the control unit is arranged to determine and set a maximal speed and/or a maximal acceleration, and/or a maximal deceleration, and/or a maximal lift height, and/or a maximal load weight, of the fork-lift truck based on the detected predetermined rotary position of the said at least one rotary axis.

2. The fork-lift truck according to claim 1, wherein the sensor device is a potentiometer, or a hall-effect element combined with a magnet, preferably the hall-effect element is a digital hall-effect element that is further combined with a group of hall-effect elements surrounding at least partly the rotary axis, such that a digital signal can be achieved as a predetermined rotary position is achieved.

3. The fork-lift truck according to claim 1, wherein the framework extension device is further associated with the mast by means of a glide connection.

4. The fork-lift truck according to claim 1, wherein the control unit is arranged such that it is able to determine a predetermined distance of the movable mast in relation to the housing based on the rotary position of the rotary axis framework extension assembly.

5. The fork-lift truck according to claim 1, wherein it is an electric fork-lift truck comprising an electric drive motor, and an electric pump motor for a comprised hydraulic system.

6. The fork-lift truck according to claim 1, wherein the sensor device is positioned at the second rotary axis.

7. A method of controlling a fork-lift truck, the fork-lift truck including:
a housing;
a mast;
an actuating device;
a framework extension assembly with at least one rotary axis;
a control unit; and
a pair of support legs;
the method comprising the steps of:
S1 providing at least one sensor device associated with at least one rotary axis of a framework extension assembly;
S2 applying the sensor device in order to detect a predetermined rotary position of the at least one rotary axis; and
S3 providing a control unit that determines and sets a maximal speed and/or a maximal acceleration, and/or a maximal deceleration, and/or a maximal lift height, and/or a maximal load weight, of the fork-lift truck based on the detected predetermined rotary position of the said at least one rotary axis.

8. The method of claim 7, further comprising:
providing computer readable software that, when executed on the control unit of the fork-lift truck, performs the method step S3.

9. A method of achieving a fork-lift truck, the method comprising the step of:
T1 providing a sensor device able to detect a rotary motion of an axis;
T2 applying said sensor device to a rotary axis of a framework extension assembly, wherein the sensor device is able to detect a predetermined rotary position of at least one rotary axis; and
T3 arranging a control unit to be able to set a maximal speed and/or a maximal acceleration, and/or a maximal deceleration, and/or a maximal lift height, and/or a maximal load weight, of the fork-lift truck based on the detected predetermined rotary position of the said at least one rotary axis.

10. The method of claim 9, further comprising providing a program stored in a non-transitory computer-readable medium, the control unit of the fork-lift truck executing the program, and the program performing the method step T3.
